(19) United States
(12) Patent Application Publication
(10) Pub. No.: US 2008/0245232 A1
(43) Pub. Date: Oct. 9, 2008

(54) Downflow Biofiltration of Hydrogen Sulfide-Containing Gas

(76) Inventor: Thomas Getz, Cicero, NY (US)

Correspondence Address: STORM LLP, BANK OF AMERICA PLAZA, 901 MAIN STREET, SUITE 7100, DALLAS, TX, 75202, US

(21) Appl. No.: 11/733,039

(22) Filed: Apr. 9, 2007

(51) Int. Cl. B01D 53/02

(52) U.S. Cl. 95/93; 95/135; 95/92; 96/256

(57) ABSTRACT

A method for treating a gas containing sulfur, the method comprising the steps of: introducing a gas into a headspace of a vessel; passing the gas through a filtration medium contained in the vessel, wherein the filtration medium comprises sulfur-oxidizing organisms, wherein the gas is passed through the filtration medium in a generally downward direction; and irrigating the filtration medium with an aqueous liquid, wherein the pH of the aqueous liquid is at least 5.

### BACKGROUND OF THE INVENTION

Biofiltration is a technology in which nuisance or polluting gases can be separated from air through the activity of microorganisms. Certain microorganisms use pollutants in the gases as fuel for energy and growth, converting the pollutants into either cell mass or mineral salts. Sulfur biofiltration is accomplished using sulfur-oxidizing bacteria which metabolize the sulfur-containing constituents, converting hydrogen-sulfide and other sulfur-containing pollutants into sulfuric acid. The sulfur-oxidizing bacteria have specific life-support requirements including the odorous compound(s), moisture, proper pH, macronutrients, such as nitrogen and phosphorus, and micronutrients, such as calcium, magnesium, iron, zinc, manganese, molybdenum, boron, copper, cobalt, selenium, chromium, and others. All living organisms require carbon, oxygen, and hydrogen and the organisms can obtain these from carbon dioxide in the waste air and water which is added to the biofilter surface and/or inlet air.

When the source of the sulfurous gas is anaerobic waste treatment, there is also methane and other gases present. The methane gas may exceed the sulfurous pollutants by orders of magnitude. This excess of methane is a problem because it can encourage the growth of non-sulfur-oxidizing bacteria if such growth is not properly controlled.

Conventional upflow biofiltration passes the odorous gas upward through the filtration media containing the microorganisms. Irrigation water flows downward through the media. The irrigation water leaches the products of decomposition downward through the biofilter and transfers them to the leachate collection system. Upflow biofiltration of hydrogen sulfide results in the greatest formation of sulfuric acid at the bottom of the filter, where the highest concentration of hydrogen sulfide is present. Most of the hydrogen sulfide is removed near the bottom of the bed. Sulfuric acid does not form near the surface of the media because the concentration of hydrogen sulfide is small compared to other gas constituents, such as methane. The downward irrigation water flow rinses the sulfuric acid out the bottom of the media. Operated in this manner, the pH at the top surface of the media is near neutral and the bottom of the media is highly acidic, often less than 1.0 standard pH units. This phenomenon is illustrated in FIG. 3a. Any number of bacteria or fungi can inhabit the neutral layer of media. This results in decomposition of the media, slime formation by the action of the microorganisms, differential water retention by the media, plugging of the media, and non-uniform airflow.

Growth-stimulating nutrients such as nitrogen and phosphorus fertilizers cannot be added to upflow biofiltration systems because these are added to the top surface and the competing organisms would assimilate the nutrients and the sulfur oxidizing bacteria low in the filter would receive little or no nutrients. Furthermore, addition of nutrients to a biofilter with wood media would accelerate the decomposition of the media near the surface in the neutral pH zone. However, the acid zone at lower elevations in the biofilter does not undergo decomposition in upflow biofiltration. The pH in the acid zone is often less than 1.0 standard units and only sulfur-oxidizing bacteria can tolerate this extremely low pH and live in the acidic media. Competing microorganisms cannot survive. Therefore, the media is preserved by the low pH, there is no slime formation and media function is preserved.

What is needed is a method and apparatus for biofiltration which results in a more even pH distribution and an acidic pH throughout the filtration media.

### SUMMARY

It is a general object of the disclosed invention to provide a method and apparatus for treating a gas containing sulfur. This and other objects of the present invention are achieved by providing:

A method for treating a gas containing sulfur, comprising the steps of introducing a gas into a headspace of a vessel; passing the gas through a filtration medium contained in the vessel, wherein the filtration medium comprises sulfur-oxidizing organisms, wherein the gas is passed through the filtration medium in a generally downward direction; and irrigating the filtration medium with an aqueous liquid, wherein the pH of the aqueous liquid is at least 5.

According to one preferred embodiment of the present invention, the method further comprises the step of maintaining an acidic pH throughout the filtration medium.

According to another embodiment, the method further comprises the step of removing treated gas from below the filtration medium.

According to another embodiment, the method further comprises the step of passing the gas through a chemical scrubber after it has passed through the filtration medium.

According to another embodiment, the method further comprises the step of maintaining a pH throughout the filtration medium which is sufficiently low to prevent the growth of organisms other than acidophilic bacteria.

According to another embodiment, the method further comprises the step of supplying biological nutrients to the sulfur-oxidizing bacteria.

According to another embodiment, a pressure drop of the gas through the filtration medium is less than 5″ of water column.

According to another embodiment, the pH difference between a top surface and a bottom surface of the filtration medium is less than 2 pH units.

According to another embodiment, the pH of the aqueous liquid is at least 3

According to another embodiment, the temperature at a point in the reaction medium is between 40° and 110° F.

According to another embodiment, wherein the pressure of the gas in the headspace is less than 1.1 atm.

### BRIEF DESCRIPTION OF THE DRAWINGS

FIG. 1 is a schematic diagram of a system for the treatment of sulfur-containing gas.

FIG. 2 is a schematic diagram of component that may be used in a system for the treatment of sulfur-containing gas, including a cross section view of a sulfur biofilter.

FIGS. 3A and 3B are partial cross section views of two biofilters illustrating the difference in pH gradient between upflow (3A) and downflow (3B) biofilter configurations.

FIG. 4 is a schematic diagram of a system for providing irrigation fluid to a biofilter.

FIG. 5 is a partial cross section view of a biofilter.

### DETAILED DESCRIPTION

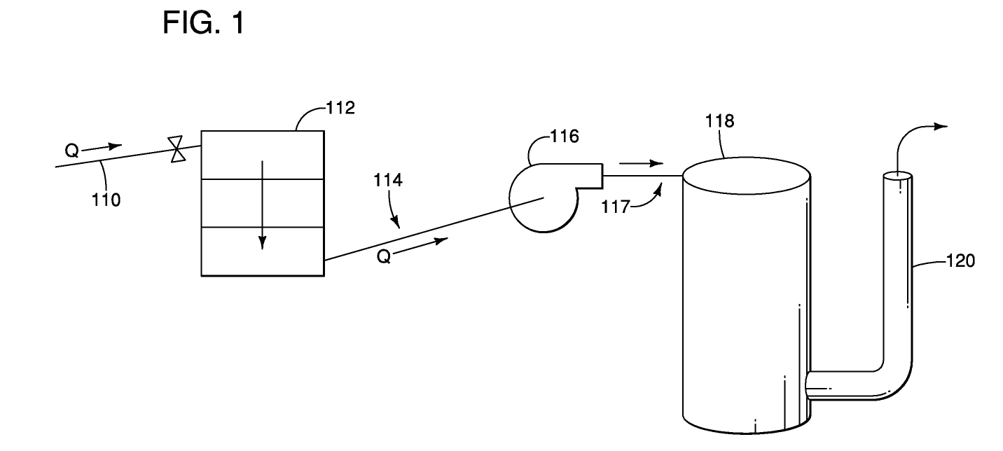

FIG. 1 is a schematic diagram of a process and apparatus for removal of sulfur impurities from a gas stream (not shown). The gas stream enters through an inlet conduit 110. Inlet conduit 110 leads into a downward-flow biofilter 112. The pressure of the gas as it enters biofilter 112 is preferably about −1.8″ water column (all pressures herein are given as gauge pressure unless otherwise noted). The gas passes through biofilter 112 and into a post-filter conduit 114. The pressure of the gas exiting the biofilter is preferably about −3.6″ water. Negative gauge pressures in the biofilter 112 are preferable so that pollutants will not leak into the atmosphere even if biofilter 112 is not perfectly airtight. This, in turn, provides a savings in material costs by allowing construction of the biofilter 112 from less expensive materials. (A biofilter with positive pressure can also employ the downflow design concept provided that biofilter vessel is airtight to prevent the leakage of odorous air from the vessel.) The gas preferably passes through the post-filter conduit 114 to a gas mover 116. Gas mover 116 is preferably a centrifugal fan that is of adequate size and power to move the quantity of odorous air that must be treated against the differential pressure across the system. The system, in this sense, is comprised of the biofilter and odor source process tanks and inlet piping and discharge piping and the treatment process downstream of the biofilter, if any. The fan size and power can be developed according to standard fan engineering practices. Other gas movers are known and may be used, such as pumps and compressors. The pressure of the gas leaving the gas mover 116 is preferably about 1.0″ water. The gas preferably passes from gas mover 116 through a post-fan conduit 117 to a chemical scrubber 118. After the chemical scrubber 118, the gas passes through a vent to the atmosphere. Alternatively, a second biofilter (not shown) unit may be used in addition to, or in place of, the chemical scrubber 118. A chemical scrubber or second biofilter or other treatment process downstream of the downflow biofilter is not essential to the downflow biofiltration process.

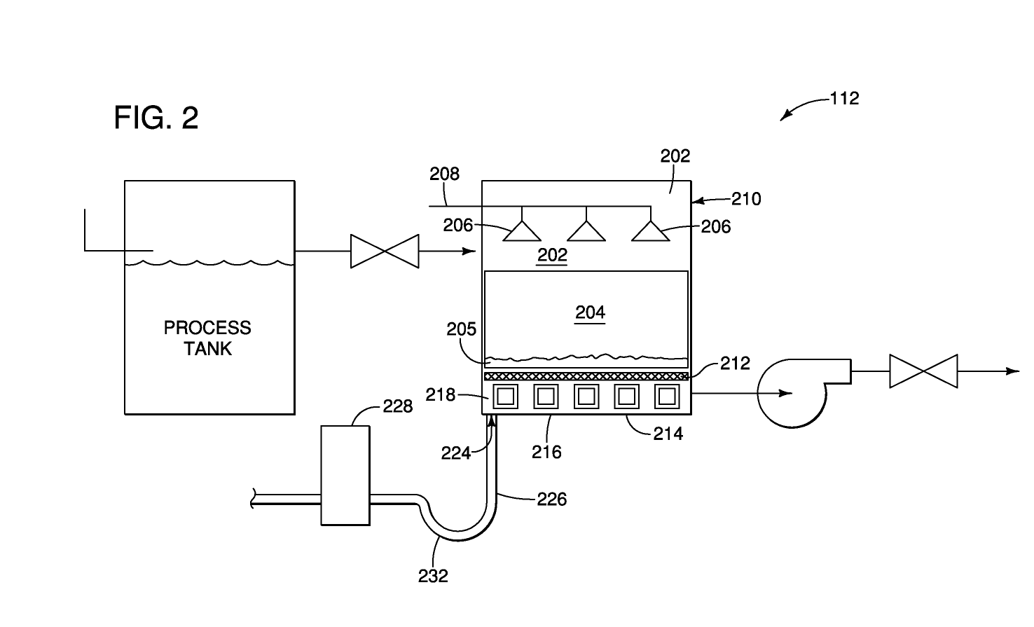

FIG. 2 shows a cross-section view of the biofilter unit 112. The biofilter unit 112 comprises a vessel 210 enclosing a space. The gas to be treated enters biofilter unit 112 from inlet conduit 110 into a headspace 202 of vessel 210. Below headspace 202 is a filtration medium 204. The filtration medium 204 comprises a packing material, a thin layer of liquid (aqueous film) which adheres to the packing material, and biofiltration organisms inhabiting the surface of the packing material and covered by the liquid. The aqueous layer and organisms combined are known as a biofilm (not shown). Odorous gases dissolve in the biofilm and microbes in the biofilm absorb and metabolize the odorous compounds, converting them into dissolved mineral products of decomposition. Many different materials, including plastic, stone, soils, peat, bark, woody materials, organic waste, and others may be used for the packing material. Ground wood, such as that available from wood recycling facilities, is advantageous for use as the packing material because it is readily available, low cost, the organic nature of the wood is readily colonized by microorganisms, and the wood absorbs water which enhances the development of the biofilm. Ground wood has the additional advantages of having very high porosity and low bulk density which enables the movement of air through the media with minimal resistance, allowing free movement of irrigation water through the media. A disadvantage of wood media is that the wood itself is subject to decomposition. The breakdown of the wood media results in higher pressure drop across the filter, waterlogging, plugging, and short circuiting. For this reason wood media is preferably replaced every 1-2 years.

New filtration medium 204 is preferably inoculated with sulfur-oxidizing bacteria to encourage quick efficacy of a new biofilter. The inoculation may be accomplished by including some media from another sulfur biofilter in the filtration medium 204. Alternatively, leachate from an operating biofilter, either upflow or downflow, may be used as source of inoculum. However, inoculation is not essential. If the conditions for bacteria growth—i.e., hydrogen sulfide and water and nutrients—are present, sulfur-oxidizing bacteria will colonize the packing material without seeding.

Filtration medium 204 must remain continuously moist or the microorganisms will be desiccated and treatment will fail. Therefore, irrigation nozzles 206 are preferably provided in the vessel 210 above the filtration medium 204. Irrigation water (not shown) is directed through irrigation conduit 208 to irrigation nozzles 206 and is sprayed onto the filtration medium 204. The quantity and frequency of irrigation depends on many factors, including the humidity of the inlet air, whether the biofilter is enclosed or open to the atmosphere, and the porosity of the filtration medium 204. Preferably, the flow rate of irrigation water is approximately 1.7 gallons per day per square foot of filter surface.

The filtration medium 204 preferably rests on a support medium 205, which rests on a grate 212. The support medium 205 is preferably a coarser variety of the same materials comprising the filtration medium 204. The purpose of the support media 205 is to control leakage of filtration medium 204 through grate 212. Alternatively, filtration medium 204 may be placed directly on the grate 212. The grate 212 is preferably on supports 214 which elevate the grate 212 above a floor 216 of the vessel 210 to create a bottom space 218. The floor 216 is preferably slightly slanted so that the irrigation water and acids dissolved therein (leachate) may be collected at a single point. Grate 212, supports 214, vessel 210 and other components that will come in contact with the leachate should be constructed from acid-resistant materials. This may be a combination of structural plastic, concrete, and/or metals protected by acid resistant coatings. In the highly-acid environment of downflow biofiltration of sulfurous odors, wood can be considered an acid-resistant construction material because it is protected from decomposition by the low pH.

A pressure difference between the headspace 202 and bottom space 218 forces the gas through the filtration medium 204. The method set forth herein for biofiltration is preferably conducted with the filtration medium 204 at mesophilic temperature ranges, i.e. between 40° and 110° F. Kinetics are expected to be greatest near 100° F. and be reduced at greater or lesser temperatures.

A floor 216 of the vessel 210 is preferably slanted toward a leachate-collection drain 224, which feeds leachate (not shown) to a leachate-disposal conduit 226, which directs leachate to a sampling manhole 228. Preferably, the leachate-disposal conduit 226 includes a p-trap 232 to prevent air from entering the vessel 210 through the leachate-disposal conduit 226 when the vessel 210 is operating under negative gauge pressure. From the sampling manhole 228, the leachate is preferably directed away for further processing at another location using known methods. Alternatively, the leachate may be recycled into the irrigation liquid or recycled further upstream in an overall process. All components that will come in contact with leachate from the filtration medium 204 must be constructed from acid-resistant materials.

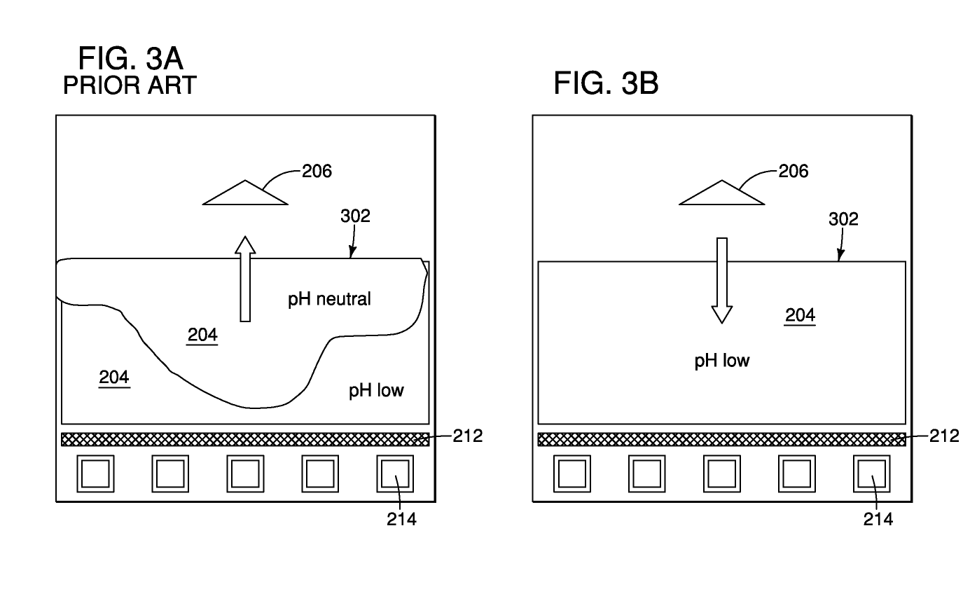

As shown in FIG. 3b, when the hydrogen sulfide is introduced at the top surface 302 of the filtration medium 204, the sulfur oxidation and acid formation will be greatest near the top surface 302 and gravitational leaching, downward airflow, and irrigation flow will assure that the media below is also highly acidic. The irrigation liquid rinses the media below with sulfuric acid and eliminates virtually all organisms except for the acidophilic (acid loving) sulfur-oxidizing bacteria. Thus, downflow biofiltration favors the acidophilic, sulfur-oxidizing bacteria at the expense of other organisms. Without the competing organisms being present, growth-stimulating nutrients, such as nitrogen and phosphorus fertilizers, can be added to the top surface 302 of the filtration media 204 and the sulfur-oxidizing bacteria will assimilate the nutrients and proliferate. This results in improved performance of the biofiltration process as measured by percentage and total sulfur removed.

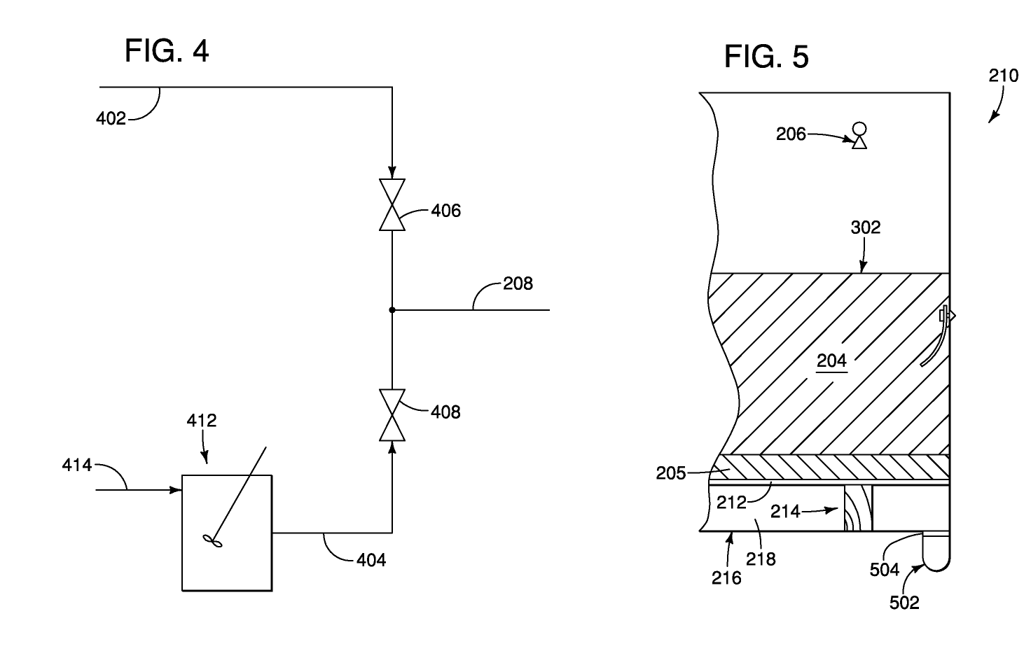

FIG. 4 shows a schematic diagram of a system for adding nutrients to the filtration medium 204. Irrigation conduit 208 is fed by two sources—a clean feed line 402 and a mixed feed line 404. The amount of irrigation liquid entering irrigation conduit 208 from clean feed line 402 and mixed feed line 404 is controlled by valves 406 and 408, respectively. Clean feed line 402 preferably provides tap water (not shown). The mixed feed line 404 preferably provides water mixed with nutrients (not shown). Nutrients are preferably added to water in a mixer 412 which feeds the mixed feed line 404. Water enters the mixer through a water feed line 414. Nutrients do not need to be supplied on a continuous basis. Further, constant irrigation with water after nutrients have been delivered to the filtration medium 204 will wash away much of the nutrients before they can be absorbed by the organisms. Therefore, the preferable operation is to temporarily stop the flow through the clean feed line 402, deliver nutrients through the mixed feed line 404 and not restart the clean feed line 402 flow until the organisms have had time to absorb the nutrients—preferably at least 24 hours. Alternatively to using only clean tap water and nutrient-infused tap water as the irrigation liquid, some or all of the biofilter leachate may by recycled through the irrigation conduit 208. However, this practice is not preferred.

### EXAMPLE 1

An experiment was conducted using a downflow biofilter to remove hydrogen sulfide from off gas from a wastewater treatment facility. The biofilter was a rectangular vessel approximately 24′ long by 36′ wide by 10′ high. The biofilter was divided into three cells approximately 24′ long by 12′ wide which operate in parallel. The vessel includes a wall flap to prevent short circuiting along the wall. The biofilter operates with a pressure differential of 1.4″ water column between inlet and outlet with an airflow loading of 2.3 cfm/square foot of filter surface, or approximately 1989 cfm total at the inlet. Due to ambient air leaking into the biofilter, the total flow was about 2391 cfm at the outlet. The low differential pressure across the filtration media reduces the power cost to move the odorous air through the biofilter. The biofilter operates with a gauge pressure of −3.6″ water column at the outlet. The low operating pressure avoids the need to design the vessel with the structural strength to withstand the static pressure loads that result from a vessel operated with higher pressures. The centrifugal fan used is manufactured by Hartzell. The impeller is about 22″ in diameter. The discharge port is 12″ by 15″. The motor is 15 HP and 1800 RPM. The impeller is belt driven and sheaves were installed to run the fan at 2300 cfm with slight throttling at the inlet and outlet pressures.

The demonstration downflow biofilter operates with an irrigation rate of 1.7 gallons per day per square foot of filter surface, or approximately 1440 gallons per day total. The irrigation was done at a rate of 40 gallons per minute per cell for 2 minutes, 6 times per day. The biofilter was operated at temperatures as low as 75° and as high as 100° F. At lower temperatures the biofiltration process is expected to continue but with lower removal rates until it fails near 40° F. At higher temperatures the biofiltration process is expected to continue but with lower removal rates until it fails near 110° F.

FIG. 5 shows a vertical profile of the filtration portions of the biofilter vessel. The top of grate 212 is defined as the zero point. The top of supports 214 is at −1″. The floor 216 of vessel 210 is at −13″. Along a wall of vessel 210 is a drain trench 502. The bottom of drain trench 502 is at −21″. A drain trench grate 504 preferably covers the drain trench 502. Above the grate is support medium 205, which is approximately 6″ deep. Support medium 205 is preferably coarse ground wood. Above support medium 205 is filtration medium 204, which extends about 42″ from the top of support medium 205. Approximately 29″ above the top surface 302 of filtration medium 204 is the bottom of the irrigation nozzles 206. The ceiling of the vessel 210 is approximately 89″ above the top of grate 212.

The packing material for the filtration medium 204 may be ground wood or other acid-resistant materials. The specification of the media used in the demonstration biofilter is as follows:

The ground wood or hogwood used in the filtration medium should be a minimum of 45% dry solids on a weight basis. It should be seasoned hardwood twice ground in a hammermill with a 2″ screen. Preferable raw materials for producing hogwood are clean pallets, crates, scrap lumber, sawn wood boards or sawmill scrap. Hogwood should not be produced from green logs, coniferous woods, bark, brush, small limbs or twigs, grass clippings, leaves, etc. The expected appearance of hogwood so produced is rectangular, splintered particles, comprised of a range of sizes, which length varies from 0.5″ to 5.0″ and is approximately 4 to 8 times the thickness and generally free of dust and fines. Hogwood should be free from contamination by non-wood materials, e.g., nails, staples, metals, plastic, rock, glass, soil, paper, chemicals, etc. Hogwood should not be produced from wood which has been coated, pressure treated or preserved such as woods containing creosote, pentachlorophenol, copper, arsenic, chromium, other metallic compounds, paint, varnish, other coatings, resins and adhesives.

Particles exceeding 6″ in length or 2″ in thickness or width are not preferred. Particles exceeding 3″ in thickness plus width are not preferred. Preferably, no more than 50% of particles should pass through a ½″ sieve vibrated for 2 minutes and no more than 25% of particles should pass through a ¼″ sieve vibrated for 2 minutes.

The packing material for this experiment was produced using a double grind through a Morbark 1300A Grinder. The grinder was fitted with a 2.5″ square screen on one side and a 2.0″ round screen on the other.

Generally, the desired distribution of particle sizes is as shown in FIG. 6. Media selection is not limited to the distribution shown. A wide range of particle distributions will be functional. The selection of particle size distribution is a trade-off between biological and pneumatic performance. A smaller distribution will have greater surface area and better sulfur removal but also greater resistance to airflow.

1. A method for treating a gas containing sulfur, the method comprising the steps of:
introducing a gas into a headspace of a vessel;
passing the gas through a filtration medium contained in the vessel, wherein the filtration medium comprises sulfur-oxidizing organisms, wherein the gas is passed through the filtration medium in a generally downward direction; and
irrigating the filtration medium with an aqueous liquid, wherein the pH of the aqueous liquid is at least 3.

2. The method of claim 1, further comprising the step of maintaining an acidic pH throughout the filtration medium.

3. The method of claim 1, further comprising the step of removing treated gas from below the filtration medium.

4. The method of claim 1, further comprising the step of passing the gas through a chemical scrubber after it has passed through the filtration medium.

5. The method of claim 1, further comprising the step of maintaining a pH throughout the filtration medium which is sufficiently low to prevent the growth of organisms other than acidophilic bacteria.

6. The method of claim 1, further comprising the step of supplying biological nutrients to the sulfur-oxidizing bacteria.

7. The method of claim 1, wherein a pressure drop of the gas through the filtration medium is less than 5″ of water column.

8. The method of claim 1, wherein the pH difference between a top surface and a bottom surface of the filtration medium is less than 2 pH units.

9. The method of claim 1, wherein the pH of the aqueous liquid is at least 5

10. The method of claim 1, wherein the temperature at a point in the reaction medium is between 40° and 110° F.

11. The method of claim 1, wherein the pressure of the gas in the headspace is less than 1.1 atm.

12. A method for treating a gas containing sulfur, the method comprising the step of passing the gas through a filtration medium in a generally downward direction substantially all of the time, wherein the filtration medium comprises sulfur-oxidizing organisms.

13. An apparatus for treating a gas containing sulfur, comprising:
a vessel;
a filtration medium within the vessel comprising sulfur-oxidizing organisms;
a gas inlet to the vessel, wherein the gas inlet is positioned above at least a majority of the filtration medium;
a gas outlet, wherein the gas outlet is positioned below at least a majority of the filtration medium;
a gas mover configured to provide a higher gas pressure at the gas inlet than at the gas outlet;
an irrigation nozzle within the vessel configured to supply an aqueous liquid to the filtration medium;
a first liquid supply line configured to supply a first aqueous liquid to the irrigation nozzle; and
a second liquid supply line configures to supply a second aqueous liquid to the irrigation nozzle, wherein the second aqueous liquid comprises nutrients.

14. The apparatus of claim 13, wherein the depth of the filtration medium is between 6″ and 120″.

15. The apparatus of claim 13, wherein the depth of the filtration medium is between 30″ and 60″.

16. The apparatus of claim 13, wherein the filtration medium further comprises pieces of wood.
